(19) United States
(12) Patent Application Publication
(10) Pub. No.: US 2026/0349321 A1
(43) Pub. Date: Nov. 5, 2026

(54) MULTICOLOR LIGHT-MIXING MODULE AND LASER PROJECTION APPARATUS THEREOF

(71) Applicant: QISDA CORPORATION, Taoyuan City (TW)

(72) Inventors: Chih-Shiung Chien, Taoyuan City (TW); Ming-Kuen Lin, Taoyuan City (TW)

(73) Assignee: QISDA CORPORATION, Taoyuan City (TW)

(21) Appl. No.: 19/647,832

(22) Filed: Apr. 14, 2026

(30) Foreign Application Priority Data
Apr. 30, 2025 (CN) 202510570578.9

(51) Int. Cl. G03B 21/20; G02B 26/00; G03B 33/12

(52) U.S. Cl. CPC G03B 21/204; G02B 26/008; G03B 21/2066; G03B 21/208; G03B 33/12

(57) ABSTRACT

A multicolor light-mixing module includes a condensing lens, a laser source, a reflective diffuser, an exciting source, a wavelength-conversion module and a light-mixing member. The laser source is disposed on a light-entrance axis of the condensing lens. The reflective diffuser is disposed at a side of the condensing lens for receiving and reflecting a color light from the condensing lens to travel along a light-mixing axis of the condensing lens. The exciting source emits an exciting light along a light-emitting axis perpendicular to the light-entrance and light-mixing axes. The wavelength-conversion module is disposed at the light-emitting axis for converting the exciting light into a converted light. The light-mixing member is disposed on the light-mixing and light-emitting axes to partially reflect the converted light and allow the color light to pass through, for mixing the converted light and the color light to form a multicolor laser beam along the light-mixing axis.

### BACKGROUND OF THE INVENTION

### 1. FIELD OF THE INVENTION

The present invention relates to a multicolor light-mixing module and a laser projection apparatus thereof, and more specifically, to a multicolor light-mixing module utilizing a wavelength-conversion module to generate a converted light and utilizing a light-mixing member to reflect the converted light and allow color light of a laser source to pass through and a laser projection apparatus thereof.

### 2. DESCRIPTION OF THE PRIOR ART

In general, a conventional laser projection apparatus adopts a light-mixing module to provide a multicolor laser beam for subsequent image projection. In the practical application, for further reducing an overall volume of a laser source of the laser projection apparatus, the common design involves packaging red, green, and blue laser diodes in a side-by-side arrangement into one multicolor laser source module, so as to simultaneously provide red, green and blue color lights to the light-mixing module of the laser projection apparatus.

However, since the aforesaid packaging design only arranges the red, green, and blue laser diodes in multiple rows sequentially (e.g., arranging a plurality of red laser diodes in a row and arranging a plurality of green and blue laser diodes in another row), it may cause an uneven color distribution problem on an image projected by the laser projection apparatus (e.g., the image having a greenish upper portion and a bluish lower portion). Furthermore, the laser speckle problem may also occur due to high coherence of the laser beam. The aforesaid problems reduce the image projection quality of the laser projection apparatus.

### SUMMARY OF THE INVENTION

The present invention provides a multicolor light-mixing module suitable for providing a multicolor laser beam to a laser projection apparatus. The multicolor light-mixing module includes a condensing lens, a laser source, a reflective diffuser, a first exciting source, a wavelength-conversion module, and a light-mixing member. The condensing lens has a first lens portion and a second lens portion, wherein the first lens portion has a light-entrance axis, and the second lens portion has a light-mixing axis. The laser source is disposed on the light-entrance axis and emits at least one color light to the condensing lens. The reflective diffuser is disposed on one side of the condensing lens, for receiving the at least one color light transmitted from the first lens portion and reflecting the at least one color light to the second lens portion, so that the at least one color light travels along the light-mixing axis. The first exciting source emits a first exciting light along a first light-emitting axis, wherein the first light-emitting axis is perpendicular to the light-entrance axis and the light-mixing axis. The wavelength-conversion module is disposed on the first light-emitting axis, for performing wavelength conversion on the first exciting light to generate at least one first converted light. The light-mixing member is disposed on the light-mixing axis and the first light-emitting axis, for reflecting a portion of the at least one first converted light transmitted from the wavelength-conversion module and allowing the at least one color light transmitted from the second lens portion to pass through, so that the at least one first converted light and the at least one color light are mixed along the light-mixing axis to form the multicolor laser beam.

The present invention further provides a laser projection apparatus including a multicolor light-mixing module, an imaging module and a projection lens. The multicolor light-mixing module is suitable for providing a multicolor laser beam to a laser projection apparatus. The multicolor light-mixing module includes a condensing lens, a laser source, a reflective diffuser, a first exciting source, a wavelength-conversion module, and light-mixing member. The condensing lens has a first lens portion and a second lens portion. The laser source is disposed on a light-entrance axis of the first lens portion and emits at least one color light to the condensing lens. The reflective diffuser is disposed on one side of the condensing lens, for receiving the at least one color light transmitted from the first lens portion and reflecting the at least one color light to the second lens portion, so that the at least one color light travels along a light-mixing axis of the second lens portion. The first exciting source emits a first exciting light along a first light-emitting axis, wherein the first light-emitting axis is perpendicular to the light-entrance axis and the light-mixing axis. The wavelength-conversion module is disposed on the first light-emitting axis, for performing wavelength conversion on the first exciting light to generate at least one first converted light. The light-mixing member is disposed on the light-mixing axis and the first light-emitting axis, for reflecting a portion of the at least one first converted light transmitted from the wavelength-conversion module and allowing the at least one color light transmitted from the second lens portion to pass through, so that the at least one first converted light and the at least one color light are mixed along the light-mixing axis to form the multicolor laser beam. The imaging module receives the multicolor laser beam transmitted from the multicolor light-mixing module to form a projection beam. The projection lens receives the projection beam transmitted from the imaging module for optical projection.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a laser projection apparatus according to an embodiment of the present invention.

FIG. 2 is a diagram of a correspondence relationship between the transmittance and the color-light wavelength of a light-mixing member in FIG. 1.

FIG. 3 is a diagram of a laser projection apparatus according to another embodiment of the present invention.

### DETAILED DESCRIPTION

The following content illustrates the technical content of the present invention with reference to specific embodiments and the accompanying drawings. Persons skilled in the art can easily understand other advantages and effects of the present invention from the contents disclosed in this specification. The present invention may also be implemented or applied through other different specific embodiments. Various details in this specification may also be modified and changed based on different viewpoints and applications without departing from the spirit of the present invention. In particular, the structural design and positional relationship of each component in the drawings (e.g., structural proportions and arrangement of each optical component in a light-mixing module and the related light path design) are for exemplary purposes only and do not represent the actual implementation status of the present invention.

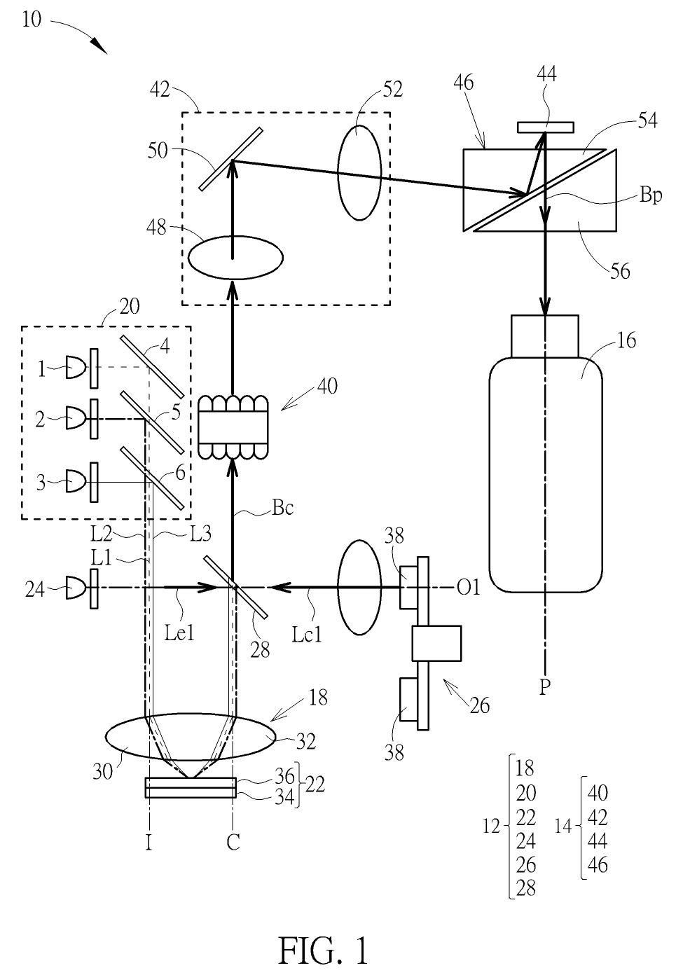

Please refer to FIG. 1, which is a diagram of a laser projection apparatus 10 according to an embodiment of the present invention. As shown in FIG. 1, the laser projection apparatus 10 is used for performing laser projection imaging. The laser projection apparatus 10 includes a multicolor light-mixing module 12, an imaging module 14, and a projection lens 16. The multicolor light-mixing module 12 is adapted to provide a mixed beam to the laser projection apparatus 10 for subsequent projection imaging. The multicolor light-mixing module 12 includes a condensing lens 18, a laser source 20, a reflective diffuser 22, a first exciting source 24, a wavelength-conversion module 26, and a light-mixing member 28.

The condensing lens 18 could preferably be a collimator lens (but not limited thereto) having a first lens portion 30 and a second lens portion 32, for collimating and condensing color light emitted by the laser source 20. The laser source 20 is disposed on a light-entrance axis I of the first lens portion 30 and emits color light to the condensing lens 18. In this embodiment, the laser source 20 could preferably include a first lighting unit 1, a second lighting unit 2, and a third lighting unit 3 (but not limited thereto, meaning that the present invention could also adopt only one single lighting unit or two lighting units). In FIG. 1, one first lighting unit 1, one second lighting unit 2, and one third lighting unit 3 are shown respectively, and the number and arrangement of lighting units depend on the actual application of the laser projection apparatus 10. In this embodiment, the first lighting unit 1 could preferably be a red laser diode to emit a first color light L1 with red light, and a wavelength of the first color light L1 could be between 639nm and 647nm. The second lighting unit 2 could preferably be a green laser diode to emit a second color light L2 with green light, and a wavelength of the second color light L2 could be 525nm. The third lighting unit 3 could preferably be a blue laser diode to emit a third color light L3 with blue light, and a wavelength of the third lighting unit 3 could be 465nm. However, the present invention is not limited thereto, meaning that the types of color lights could vary according to the actual light-mixing application of the laser projection apparatus 10.

In practical applications, the laser source 20 could preferably adopt a light refracting design. For example, as shown in FIG. 1, the laser source 20 could further include a reflective sheet 4, a first dichroic sheet 5, and a second dichroic sheet 6. The reflective sheet 4 could be disposed obliquely on the light-entrance axis I at a position opposite to the first lighting unit 1 (the inclination angle of the reflective sheet 4 relative to the light-entrance axis I could preferably be equal to 45°, but not limited thereto) to reflect the first color light L1 to travel along the light-entrance axis I. The first dichroic sheet 5 could be disposed obliquely on the light-entrance axis I at a position opposite to the second lighting unit 2 (the inclination angle of the first dichroic sheet 5 relative to the light-entrance axis I could preferably be equal to 45°, but not limited thereto) to reflect the second color light L2 to travel along the light-entrance axis I and allow the first color light L1 to pass through. The second dichroic sheet 6 could be disposed obliquely on the light-entrance axis I at a position opposite to the third lighting unit 3 (the inclination angle of the second dichroic sheet 6 relative to the light-entrance axis I could preferably be equal to 45°, but not limited thereto) to reflect the third color light L3 to travel along the light-entrance axis I and allow the first color light L1 and the second color light L2 to pass through. As such, the first color light L1, the second color light L2, and the third color light L3 can be mixed along the light-entrance axis I and pass through the first lens portion 30, thereby making the mixed beam incident onto the reflective diffuser 22.

The reflective diffuser 22 is disposed on one side of the condensing lens 18 to receive the first color light L1, the second color light L2, and the third color light L3 transmitted from the first lens portion 30 for light diffusion and homogenization and then reflect the first color light L1, the second color light L2, and the third color light L3 to travel along a light-mixing axis C of the second lens portion 32 via the second lens portion 32. More specifically, in this embodiment, the reflective diffuser 22 could include a reflective sheet 34 and a haze diffusion layer 36. The haze diffusion layer 36 could be formed by machining (e.g., Metal Bump), attached, or coated on the reflective sheet 34, so that the first color light L1, the second color light L2, and the third color light L3 can pass through the second lens portion 32 after being homogenized and reflected by the reflective diffuser 22. The reflective sheet 34 could preferably be a metal plate or a reflective mirror, and a haze of the haze diffusion layer 36 could preferably be greater than 1.5 (but not limited thereto). Furthermore, the present invention could adopt a design in which the reflective diffuser is movably disposed on one side of the condensing lens to further improve the diffusive reflection effect of the reflective diffuser and prevent the reflective diffuser from overheating. For example, the reflective diffuser 22 shown in FIG. 1 can reciprocate relative to the condensing lens 18 (e.g., moving left and right along a horizontal direction of FIG. 1, but not limited thereto), or in another embodiment, the reflective diffuser 22 can be a diffusion wheel rotating relative to the condensing lens 18.

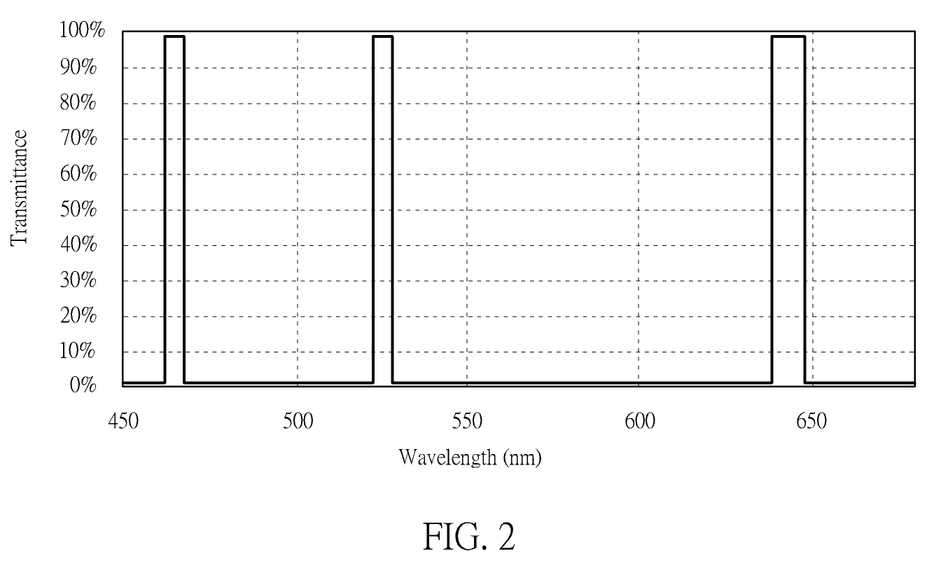

The first exciting source 24 could be a laser source to emit a first exciting light Le1 with blue light along a first light-emitting axis O1 (but not limited thereto, meaning that the types of color lights and the number of light sources may vary according to the actual light-mixing application of the multicolor light-mixing module 12). The first light-emitting axis O1 could preferably be perpendicular to the light-entrance axis I and the light-mixing axis C. The wavelength-conversion module 26 could preferably be a phosphor wheel rotatably disposed on the first light-emitting axis O1 and could have at least one phosphor layer 38 (two shown in FIG. 1, but not limited thereto) arranged sequentially around a periphery of the phosphor wheel, thereby exciting and converting the first exciting light Le1 into a first converted light Lc1. The light-mixing member 28 could be a dichroic mirror and faces the first exciting source 24 obliquely (the inclination angle of the light-mixing member 28 could preferably be equal to 45°, but not limited thereto) and is disposed on the light-mixing axis C and the first light-emitting axis O1. The correspondence relationship between the transmittance and the color-light wavelength of the light-mixing member 28 can preferably be as shown in FIG. 2 (but not limited thereto, meaning that the correspondence relationship can vary according to the actual light-mixing application of the laser projection apparatus 10). That is to say, except for color lights with wavelengths of 465nm, 525nm, and wavelengths between 639nm and 647nm, the light-mixing member 28 reflects all color lights with other wavelengths.

In summary, the light-mixing member 28 can be used to allow the first color light L1 (with a wavelength between 639nm and 647nm), the second color light L2 (with a wavelength of 525nm), and the third color light L3 (with a wavelength of 465nm), which are transmitted from the second lens portion 32, to pass through and to reflect a portion of the first converted light Lc1 transmitted from the wavelength-conversion module 26. As such, the first converted light Lc1 can be mixed with the first color light L1, the second color light L2, and the third color light L3 along the light-mixing axis C to form a multicolor laser beam Bc.

More specifically, as the phosphor wheel rotates, the first exciting light Le1 emitted by the first exciting source 24 along the first light-emitting axis O1 can be excited by the phosphor layer 38 to generate the first converted light Lc1 incident onto the light-mixing member 28 when the first exciting light Le1 is incident onto the wavelength-conversion module 26. For example, the first exciting source 24 can emit the first exciting light Le1 with blue light (with a wavelength of 465nm), and the phosphor layer 38 can correspondingly be a green phosphor layer and a red phosphor layer (but not limited thereto, meaning that the types of color lights and the color types of phosphor layers can vary according to the actual light-mixing requirements of the light-mixing module 100). Accordingly, the phosphor layer 38 can sequentially convert the first exciting light Le1 into the first converted light Lc1 with green light and red light (the converted wavelength is approximately between 500nm and 680nm), so that the first converted light Lc1 can be partially reflected by the light-mixing member 28 and mixed with the first color light L1, the second color light L2, and the third color light L3 transmitted from the second lens portion 32 and passing through the light-mixing member 28 along the light-mixing axis C, thereby providing the multicolor laser beam Bc to the laser projection apparatus 10 for projection imaging.

AS shown in FIG. 1, the imaging module 14 is disposed on the light-mixing axis C to receive the multicolor laser beam Bc transmitted from the multicolor light-mixing module 12 to form a projection beam Bp, and the projection lens 16 can receive the projection beam Bp transmitted from the imaging module 14 to perform optical projection.

To be more specific, in this embodiment, the imaging module 14 could include a homogenizing member 40, a relay lens module 42, an imaging member 44, and a prism member 46. The homogenizing member 40 could preferably be a lens array or other lens components with similar functions (but not limited thereto) and is disposed on the light-mixing axis C to perform light homogenization on the multicolor laser beam Bc transmitted from the light-mixing member 28, thereby generating effects of beam splitting, beam shaping, and spot superposition. The relay lens module 42 is disposed on the light-mixing axis C to receive the multicolor laser beam Bc transmitted from the homogenizing member 40. In this embodiment, the relay lens module 42 could include a first relay lens 48, a reflective mirror 50, and a second relay lens 52 (but not limited to this configuration). The first relay lens 48 could be located between the reflective mirror 50 and the homogenizing member 40, and the second relay lens 52 could be located between the reflective mirror 50 and the prism member 46. As such, the multicolor laser beam Bc can be reflected from the first relay lens 48 via the reflective mirror 50 to the second relay lens 52 for producing a magnifying transmission effect. The imaging member 44 is disposed on a projection axis P of the projection lens 16. The prism member 46 is disposed on the projection axis P of the projection lens 16 and is located between the projection lens 16 and the imaging member 44. In this embodiment, the prism member 46 could include a first right-angle prism 54 and a second right-angle prism 56 disposed on the projection axis P and opposite to each other. The imaging member 44 could preferably be a Digital Micromirror Device (DMD) and located on one side of the first right-angle prism 54. Accordingly, the first right-angle prism 54 can reflect the multicolor laser beam Bc transmitted from the relay lens module 42 to the imaging member 44. Subsequently, the imaging member 44 can perform optical reflection imaging on the multicolor laser beam Bc to form the projection beam Bp, so that the projection beam Bp can sequentially pass through the first right-angle prism 54 and the second right-angle prism 56 and be incident onto the projection lens 16 for the laser projection apparatus 10 to perform subsequent projection imaging.

Via the aforementioned design of utilizing the reflective diffuser to diffuse and homogenize the color light of the laser source for laser speckle removal, utilizing the wavelength-conversion module to generate the converted light for improving projection brightness and increasing the color gamut range, and utilizing the light-mixing member to reflect the converted light of the wavelength-conversion module and allow the color light of the laser source to pass through, the multicolor light-mixing module of the present invention can provide a despeckled laser beam having multicolor lights with multicolor light distributed in proper proportions. In such a manner, the present invention can efficiently solve the uneven color distribution problem on the image projected by the laser projection apparatus (e.g., the image having a greenish upper portion and a bluish lower portion) and the laser speckle problem aforementioned in the prior art, so as to greatly improve the image projection quality and color uniformity of the laser projection apparatus.

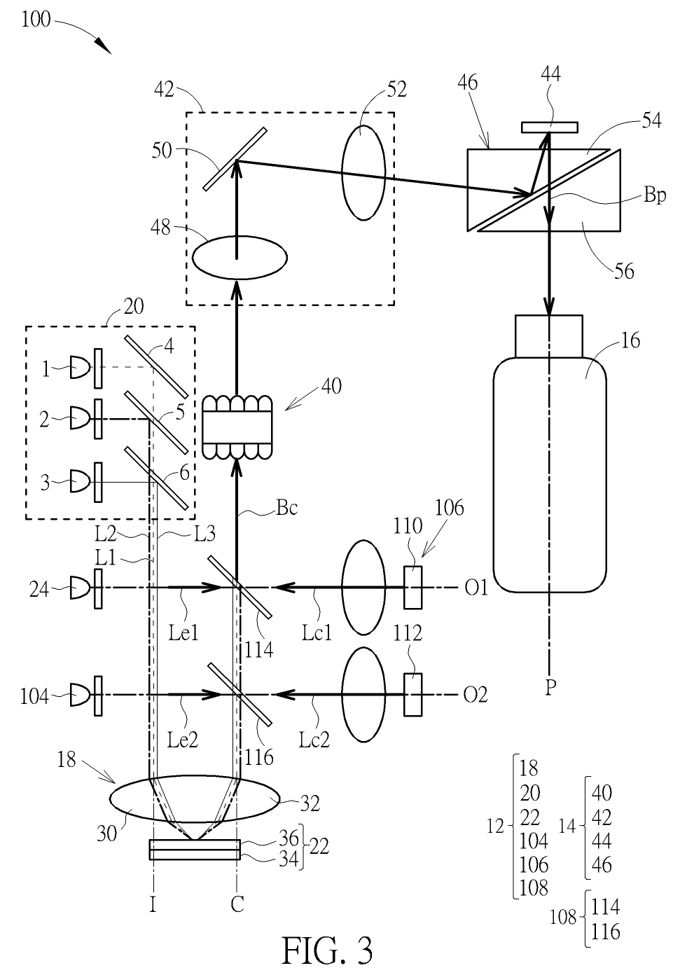

It should be mentioned that the wavelength-conversion design of the present invention is not limited to the aforesaid embodiment. For example, please refer to FIG. 3, which is a diagram of a laser projection apparatus 100 according to another embodiment of the present invention. Components both mentioned in this embodiment and the aforesaid embodiment represent components with similar structures or functions, and the related description could be reasoned by analogy according to the aforesaid embodiments and omitted herein. As shown in FIG. 3, the laser projection apparatus 100 includes a multicolor light-mixing module 102, the imaging module 14, and the projection lens 16. The multicolor light-mixing module 102 includes the condensing lens 18, the laser source 20, the reflective diffuser 22, the first exciting source 24, a second exciting source 104, a wavelength-conversion module 106, and a light-mixing member 108. The second exciting source 104 could be a laser source to emit a second exciting light Le2 with blue light along a second light-emitting axis O2 (but not limited thereto, meaning that the type of color light and the number of light sources may vary according to the actual light-mixing application of the multicolor light-mixing module 102). The second light-emitting axis O2 could preferably be perpendicular to the light-entrance axis I and the light-mixing axis C. The wavelength-conversion module 106 could include a first phosphor layer 110 and a second phosphor layer 112. The first phosphor layer 110 is disposed on the first light-emitting axis O1 to perform wavelength conversion on the first exciting light Le1 to generate the first converted light Lc1. The second phosphor layer 112 is disposed on the second light-emitting axis O2 to perform wavelength conversion on the second exciting light Le2 to generate a second converted light Lc2. The present invention could adopt a design in which the first phosphor layer 110 and the second phosphor layer 112 are movably disposed to further improve the diffusion and conversion effect of the wavelength-conversion module 106 and prevent the wavelength-conversion module 106 from overheating. For example, the first phosphor layer 110 and the second phosphor layer 112 as shown in FIG. 3 can reciprocate (e.g., move up and down along the vertical direction in FIG. 3, but not limited thereto). The light-mixing member 108 could include a first dichroic mirror 114 and a second dichroic mirror 116. The first dichroic mirror 114 is disposed on the light-mixing axis C and the first light-emitting axis O1 and faces the first exciting source 24 obliquely (the inclination angle of the first dichroic mirror 114 could preferably be equal to 45°, but not limited thereto). The second dichroic mirror 116 is disposed on the light-mixing axis C and the second light-emitting axis O2 and faces the second exciting source 104 obliquely (the inclination angle of the second dichroic mirror 116 could preferably be equal to 45°, but not limited thereto). The correspondence relationship between the transmittance and the color light wavelength of the first dichroic mirror 114 and the second dichroic mirror 116 could be reasoned by analogy according to FIG. 2 (but not limited thereto, meaning that the aforesaid correspondence relationship can vary according to the actual light-mixing application of the laser projection apparatus 100). That is to say, except for color lights with wavelengths of 465nm, 525nm, and wavelengths between 639 nm and 647 nm, the first dichroic mirror 114 and the second dichroic mirror 116 reflect all color lights of other wavelengths.

In such a manner, the first dichroic mirror 114 can allow the first color light L1, the second color light L2, and the third color light L3, which are mixed and transmitted from the second lens portion 32, and reflect a portion of the first converted light Lc1 transmitted from the first phosphor layer 110. The second dichroic mirror 116 can allow the first color light L1, the second color light L2, and the third color light L3 to pass through and reflect a portion of the second converted light Lc2 transmitted from the second phosphor layer 112. Accordingly, the first converted light Lc1 can be mixed with the second converted light Lc2, the first color light L1, the second color light L2, and the third color light L3 along the light-mixing axis C to form the multicolor laser beam Bc.

More specifically, the first exciting light Le1 and the second exciting light Le2 can be respectively excited by the first phosphor layer 110 and the second phosphor layer 112 when the first exciting light Le1 is incident onto the wavelength-conversion module 106, so as to generate the first converted light Lc1 and the second converted light Lc2 incident onto the light-mixing member 108. For example, the first exciting source 24 and the second exciting source 104 can emit the first exciting light Le1 and the second exciting light Le2 with blue light (with a wavelength of 465nm), and the first phosphor layer 110 and the second phosphor layer 112 can be respectively a red phosphor layer and a green phosphor layer (but not limited thereto, meaning that the types of color lights and the color types of phosphor layers can vary according to the actual light-mixing requirements of the laser projection apparatus 100). As such, the first phosphor layer 110 and the second phosphor layer 112 can convert the first exciting light Le1 and the second exciting light Le2 respectively into the first converted light Lc1 of red light and the second converted light Lc2 of green light (the converted light wavelengths are approximately between 500nm and 680nm), so that the first converted light Lc1 and the second converted light Lc2 can be partially reflected by the first dichroic mirror 114 and the second dichroic mirror 116 respectively, and mixed with the first color light L1, the second color light L2, and the third color light L3, which are transmitted from the second lens portion 32 and pass through the first dichroic mirror 114 and the second dichroic mirror 116, along the light-mixing axis C, thereby providing the multicolor laser beam Bc for the laser projection apparatus 100 to perform projection imaging.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A multicolor light-mixing module suitable for providing a multicolor laser beam to a laser projection apparatus, the multicolor light-mixing module comprising:
a condensing lens having a first lens portion and a second lens portion, wherein the first lens portion has a light-entrance axis, and the second lens portion has a light-mixing axis;
a laser source disposed on the light-entrance axis and emitting at least one color light to the condensing lens;
a reflective diffuser disposed on one side of the condensing lens, for receiving the at least one color light transmitted from the first lens portion and reflecting the at least one color light to the second lens portion, so that the at least one color light travels along the light-mixing axis;
a first exciting source emitting a first exciting light along a first light-emitting axis, wherein the first light-emitting axis is perpendicular to the light-entrance axis and the light-mixing axis;
a wavelength-conversion module disposed on the first light-emitting axis, for performing wavelength conversion on the first exciting light to generate at least one first converted light; and
a light-mixing member disposed on the light-mixing axis and the first light-emitting axis, for reflecting a portion of the at least one first converted light transmitted from the wavelength-conversion module and allowing the at least one color light transmitted from the second lens portion to pass through, so that the at least one first converted light and the at least one color light are mixed along the light-mixing axis to form the multicolor laser beam.

2. The multicolor light-mixing module of claim 1, wherein the reflective diffuser comprises a reflective sheet and a haze diffusion layer, the haze diffusion layer is formed by machining, attached, or coated on the reflective sheet, and the at least one color light passes through the second lens portion after the at least one color light is homogenized and reflected by the reflective diffuser.

3. The multicolor light-mixing module of claim 1, wherein the reflective diffuser is movably or rotatably disposed on the one side of the condensing lens.

4. The multicolor light-mixing module of claim 1, wherein the wavelength-conversion module is a phosphor wheel, the phosphor wheel is rotatably disposed on the first light-emitting axis and has at least one phosphor layer arranged sequentially around a periphery of the phosphor wheel, and the at least one phosphor layer converts the first exciting light into the at least one first converted light; the light-mixing member is a dichroic mirror to partially reflect the at least one first converted light and allow the at least one color light to pass through, so that the at least one first converted light and the at least one color light are mixed along the light-mixing axis to form the multicolor laser beam.

5. The multicolor light-mixing module of claim 4, wherein the condensing lens is a collimator lens, the first exciting source is a laser source, the first exciting light is blue light, and the at least one phosphor layer comprises a green phosphor layer and a red phosphor layer.

6. The multicolor light-mixing module of claim 1, wherein the multicolor light-mixing module further comprises a second exciting source, the second exciting source emits a second exciting light along a second light-emitting axis, and the second light-emitting axis is perpendicular to the light-entrance axis and the light-mixing axis;
the wavelength-conversion module comprises a first phosphor layer and a second phosphor layer, the first phosphor layer is disposed on the first light-emitting axis to perform wavelength conversion on the first exciting light to generate the at least one first converted light, and the second phosphor layer is disposed on the second light-emitting axis to perform wavelength conversion on the second exciting light to generate a second converted light;
the light-mixing member comprises a first dichroic mirror and a second dichroic mirror, the first dichroic mirror is disposed on the light-mixing axis and the first light-emitting axis to reflect a portion of the at least one first converted light transmitted from the first phosphor layer and allow the at least one color light transmitted from the second lens portion to pass through, and the second dichroic mirror is disposed on the light-mixing axis and the second light-emitting axis to reflect a portion of the second converted light transmitted from the second phosphor layer and allow the at least one color light transmitted from the second lens portion to pass through, so that the at least one first converted light, the second converted light, and the at least one color light are mixed along the light-mixing axis to form the multicolor laser beam.

7. The multicolor light-mixing module of claim 6, wherein the condensing lens is a collimator lens, the first exciting source and the second exciting source are laser sources, the first exciting light and the second exciting light are blue light, the first phosphor layer is one of a green phosphor layer and a red phosphor layer, and the second phosphor layer is another of the green phosphor layer and the red phosphor layer.

8. The multicolor light-mixing module of claim 1, wherein the wavelength-conversion module is movably or rotatably disposed on the one side of the condensing lens.

9. A laser projection apparatus comprising:
a multicolor light-mixing module suitable for providing a multicolor laser beam to a laser projection apparatus, the multicolor light-mixing module comprising:
a condensing lens having a first lens portion and a second lens portion;
a laser source disposed on a light-entrance axis of the first lens portion and emitting at least one color light to the condensing lens;
a reflective diffuser disposed on one side of the condensing lens, for receiving the at least one color light transmitted from the first lens portion and reflecting the at least one color light to the second lens portion, so that the at least one color light travels along a light-mixing axis of the second lens portion;
a first exciting source emitting a first exciting light along a first light-emitting axis, wherein the first light-emitting axis is perpendicular to the light-entrance axis and the light-mixing axis;
a wavelength-conversion module disposed on the first light-emitting axis, for performing wavelength conversion on the first exciting light to generate at least one first converted light; and
a light-mixing member disposed on the light-mixing axis and the first light-emitting axis, for reflecting a portion of the at least one first converted light transmitted from the wavelength-conversion module and allowing the at least one color light transmitted from the second lens portion to pass through, so that the at least one first converted light and the at least one color light are mixed along the light-mixing axis to form the multicolor laser beam;
an imaging module receiving the multicolor laser beam transmitted from the multicolor light-mixing module to form a projection beam; and
a projection lens receiving the projection beam transmitted from the imaging module for optical projection.

10. The laser projection apparatus of claim 9, wherein the reflective diffuser comprises a reflective sheet and a haze diffusion layer, the haze diffusion layer is formed by machining, attached, or coated on the reflective sheet, and the at least one color light passes through the second lens portion after the at least one color light is homogenized and reflected by the reflective diffuser.

11. The laser projection apparatus of claim 9, wherein the reflective diffuser is movably or rotatably disposed on the one side of the condensing lens.

12. The laser projection apparatus of claim 9, wherein the wavelength-conversion module is a phosphor wheel, the phosphor wheel is rotatably disposed on the first light-emitting axis and has at least one phosphor layer arranged sequentially around a periphery of the phosphor wheel, and the at least one phosphor layer converts the first exciting light into the at least one first converted light; the light-mixing member is a dichroic mirror to partially reflect the at least one first converted light and allow the at least one color light to pass through, so that the at least one first converted light and the at least one color light are mixed along the light-mixing axis to form the multicolor laser beam.

13. The laser projection apparatus of claim 12, wherein the condensing lens is a collimator lens, the first exciting source is a laser source, the first exciting light is blue light, and the at least one phosphor layer comprises a green phosphor layer and a red phosphor layer.

14. The laser projection apparatus of claim 9, wherein the multicolor light-mixing module further comprises a second exciting source, the second exciting source emits a second exciting light along a second light-emitting axis, and the second light-emitting axis is perpendicular to the light-entrance axis and the light-mixing axis;
the wavelength-conversion module comprises a first phosphor layer and a second phosphor layer, the first phosphor layer is disposed on the first light-emitting axis to perform wavelength conversion on the first exciting light to generate the at least one first converted light, and the second phosphor layer is disposed on the second light-emitting axis to perform wavelength conversion on the second exciting light to generate a second converted light;
the light-mixing member comprises a first dichroic mirror and a second dichroic mirror, the first dichroic mirror is disposed on the light-mixing axis and the first light-emitting axis to reflect a portion of the at least one first converted light transmitted from the first phosphor layer and allow the at least one color light transmitted from the second lens portion to pass through, and the second dichroic mirror is disposed on the light-mixing axis and the second light-emitting axis to reflect a portion of the second converted light transmitted from the second phosphor layer and allow the at least one color light transmitted from the second lens portion to pass through, so that the at least one first converted light, the second converted light, and the at least one color light are mixed along the light-mixing axis to form the multicolor laser beam.

15. The laser projection apparatus of claim 14, wherein the condensing lens is a collimator lens, the first exciting source and the second exciting source are laser sources, the first exciting light and the second exciting light are blue light, the first phosphor layer is one of a green phosphor layer and a red phosphor layer, and the second phosphor layer is another of the green phosphor layer and the red phosphor layer.

16. The laser projection apparatus of claim 9, wherein the wavelength-conversion module is movably or rotatably disposed on the one side of the condensing lens.

17. The laser projection apparatus of claim 9, wherein the imaging module comprises:
a light-homogenizing member disposed on the light-mixing axis for receiving the multicolor laser beam transmitted from the light-mixing member;
a relay-lens module disposed on the light-mixing axis for receiving the multicolor laser beam transmitted from the light-homogenizing member;
an imaging member disposed on a projection axis of the projection lens; and
a prism member disposed on the projection axis and located between the projection lens and the imaging member, for allowing the multicolor laser beam transmitted from the relay-lens module to pass through and be incident to the imaging member and for reflecting the projection beam returned from the imaging member toward the projection lens.

18. The laser projection apparatus of claim 17, wherein the relay-lens module comprises a first relay lens, a reflective mirror, and a second relay lens, the first relay lens is located between the reflective mirror and the light-homogenizing member, and the second relay lens is located between the reflective mirror and the prism member, such that the multicolor laser beam is reflected from the first relay lens to the second relay lens via the reflective mirror.

19. The laser projection apparatus of claim 17, wherein the prism member comprises:
a first right-angle prism disposed on the projection axis, for receiving the multicolor laser beam transmitted from the relay-lens module to perform reflection; and
a second right-angle prism disposed on the projection axis and
opposite to the first right-angle prism, for allowing the projection beam transmitted from the imaging member to pass through and be incident to the projection lens.
